(19) United States
(12) Patent Application Publication
(10) Pub. No.: US 2024/0143464 A1
(43) Pub. Date: May 2, 2024

(54) OPERATION MANAGEMENT APPARATUS, SYSTEM, METHOD, AND COMPUTER-READABLE MEDIUM

(71) Applicant: NEC Corporation, Minato-ku, Tokyo (JP)

(72) Inventor: Toru WAKITANI, Tokyo (JP)

(73) Assignee: NEC Corporation, Minato-ku, Tokyo (JP)

(21) Appl. No.: 18/280,841

(22) PCT Filed: Mar. 14, 2022
(86) PCT No.: PCT/JP2022/011283

§ 371 Date: Sep. 7, 2023

(30) Foreign Application Priority Data
Mar. 19, 2021 (JP) 2021-045834

(51) Int. Cl. G06F 11/22

(52) U.S. Cl. CPC G06F 11/2268

(57) ABSTRACT

An operation management apparatus includes: a registration unit configured to register definition information defining an item of monitoring target information in an operation system; a generation unit configured to generate an expected value table and an actual setting value table each including a column corresponding to the item; a storage unit configured to store an expected value corresponding to the item input from an outside in the column in the expected value table, and store an actual setting value corresponding to the item contained in the monitoring target information in the column in the actual setting value table; a determination unit configured to compare the expected value with the actual setting value to determine whether they match or not; and an instruction unit configured to perform an update instruction for the operation system from the actual setting value to the expected value when they do not match.

### TECHNICAL FIELD

The present invention relates to an operation management apparatus, a system, a method, and a program, and in particular to an operation management apparatus, a system, a method, and a program for managing the operation of a system.

### BACKGROUND ART

The operators of information system check logs and setting values collected from the devices and systems to be monitored, and manually take action (setting change or the like) on each system according to operation manuals or the like as necessary. Therefore, the operators are required to perform daily maintenance tasks such as setting up notifications, monitoring, and taking action for each system.

Patent Literature 1 discloses a technique for comparing an operation setting value acquired from a predetermined system with an expected value of the system, and updating the operation setting value to the expected value in a case where the operation setting values do not match. Patent Literature 2 discloses a technique for suppressing unintended changes by the administrator, even for setting items for which different setting values are set for each monitoring target device.

### CITATION LIST

### Patent Literature

Patent Literature 1: International Patent Publication No. 2019/187209
Patent Literature 2: Japanese Unexamined Patent Application Publication No. 2018-163600

### SUMMARY OF INVENTION

### Technical Problem

Here, there are a large number of monitoring targets (servers, network devices, and the like) in information systems in recent years, and the types and data amounts of parameters for comparing actual setting values with expected values are enormous. Therefore, there is a problem that settings for difference comparison and automatic repair are enormous and complicated.

The present disclosure has been made in order to solve these problems, and an object of the present disclosure is to provide an operation management apparatus, a system, a method, and a program for efficiently performing settings for monitoring, abnormality detection, and repair of systems.

### Solution to Problem

An operation management apparatus according to a first aspect of the present disclosure includes:
a registration unit configured to register definition information defining an item of monitoring target information in an operation system;
a generation unit configured to generate an expected value table and an actual setting value table each including a column corresponding to the item based on the definition information;
a storage unit configured to store an expected value corresponding to the item input from an outside in the column in the expected value table, and store an actual setting value corresponding to the item contained in the monitoring target information acquired from the operation system in the column in the actual setting value table;
a determination unit configured to compare the expected value with the actual setting value based on the definition information to determine whether the expected value and the actual setting value match or not; and an instruction unit configured to perform an update instruction for the operation system from the actual setting value to the expected value in a case where the expected value does not match the actual setting value.

An operation management system according to a second aspect of the present disclosure includes:
a monitoring target device that is included in an operation system and includes a monitoring agent; and
an operation management apparatus configured to monitor the operation system,
wherein the operation management apparatus includes:
a registration unit configured to register definition information defining an item of monitoring target information in the operation system; and
a generation unit configured to generate an expected value table and an actual setting value table each including a column corresponding to the item based on the definition information,
wherein the monitoring agent is configured to extract an actual setting value corresponding to the item from the monitoring target information acquired from the monitoring target device, and transmit the actual setting value to the operation management apparatus,
wherein the operation management apparatus further includes:
a storage unit configured to store an expected value corresponding to the item input from an outside in the column in the expected value table, and store the actual setting value received from the monitoring agent in the column in the actual setting value table;
a determination unit configured to compare the expected value with the actual setting value based on the definition information to determine whether the expected value and the actual setting value match or not; and
an instruction unit configured to output, to the monitoring agent, an update instruction from the actual setting value to the expected value in a case where the expected value does not match the actual setting value,
wherein the monitoring agent is configured to update the actual setting value to the expected value in response to the update instruction.

An operation management method according to a third aspect of the present disclosure causes a computer to execute:
registering definition information defining an item of monitoring target information in an operation system;
generating an expected value table and an actual setting value table each including a column corresponding to the item based on the definition information;
storing an expected value corresponding to the item input from an outside in the column in the expected value table;
storing an actual setting value corresponding to the item contained in the monitoring target information acquired from the operation system in the column in the actual setting value table;
comparing the expected value with the actual setting value based on the definition information to determine whether the expected value and the actual setting value match or not; and
performing an update instruction for the operation system from the actual setting value to the expected value in a case where the expected value does not match the actual setting value.

An operation management program according to a fourth aspect of the present disclosure causes a computer to execute:
a registration process of registering definition information defining an item of monitoring target information in an operation system;
a generation process of generating an expected value table and an actual setting value table each including a column corresponding to the item based on the definition information;
a storage process of storing an expected value corresponding to the item input from an outside in the column in the expected value table, and storing an actual setting value corresponding to the item contained in the monitoring target information acquired from the operation system in the column in the actual setting value table;
a determination process of comparing the expected value with the actual setting value based on the definition information to determine whether the expected value and the actual setting value match or not; and
an instruction process of performing an update instruction for the operation system from the actual setting value to the expected value in a case where the expected value does not match the actual setting value.

### Advantageous Effects of Invention

The present disclosure provides an operation management apparatus, a system, a method, and a program for efficiently performing settings for monitoring, abnormality detection, and repair of systems.

### BRIEF DESCRIPTION OF DRAWINGS

FIG. 1 is a block diagram illustrating a configuration of an operation management apparatus according to a first example embodiment.

FIG. 2 is a flowchart illustrating a flow of an operation management method according to the first example embodiment.

FIG. 3 is a block diagram illustrating an overall configuration of an operation management system according to a second example embodiment.

FIG. 4 is a block diagram illustrating a configuration of an operation management apparatus according to the second example embodiment.

FIG. 5 is a diagram illustrating an example of monitoring target connection information according to the second example embodiment.

FIG. 6 is a flowchart illustrating a flow of table generation processing according to the second example embodiment.

FIG. 7 is a diagram illustrating an example of monitoring target definition information according to the second example embodiment.

FIG. 8 is a diagram illustrating an example of column definition information according to the second example embodiment.

FIG. 9 is a diagram illustrating an example of an expected value table and an actual setting value table immediately after generation according to the second example embodiment.

FIG. 10 is a flowchart illustrating a flow of an expected value storage process according to the second example embodiment.

FIG. 11 is a flowchart illustrating a flow of an actual setting value storage process according to the second example embodiment.

FIG. 12 is a diagram illustrating an example of an expected value table and an actual setting value table after value storage according to the second example embodiment.

FIG. 13 is a flowchart illustrating a flow of difference detection and a repair process according to the second example embodiment.

FIG. 14 is a diagram illustrating a configuration example of repair definition information according to the second example embodiment.

FIG. 15 is a diagram illustrating a configuration example of workflow definition information according to the second example embodiment.

FIG. 16 is a block diagram illustrating an overall configuration of an operation management system according to a third example embodiment.

FIG. 17 is a sequence diagram illustrating a flow of monitoring and repair processing according to the third example embodiment.

FIG. 18 is a flowchart illustrating a flow of monitoring processing in the repair agent according to the third example embodiment.

### EXAMPLE EMBODIMENTS

Hereinafter, example embodiments of the present disclosure will be described in detail with reference to the drawings. In the drawings, the same or corresponding elements are denoted by the same reference numerals, and repeated description is omitted as necessary for clarity of description.

### First Example Embodiment

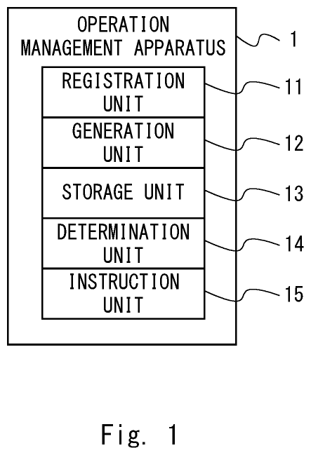

FIG. 1 is a block diagram illustrating a configuration of an operation management apparatus 1 according to a first example embodiment. The operation management apparatus 1 is an information processing device for performing operation management for an operation system. Here, the operation system is an information system including a plurality of monitoring target devices such as computers (servers), communication devices (network devices), and storage devices. The operation system is, for example, a service providing system that provides one or more services via a communication network, or a business system within a company. In addition, the operation system may be linked to an external information system.

The operation management apparatus 1 includes a registration unit 11, a generation unit 12, a storage unit 13, a determination unit 14, and an instruction unit 15. The registration unit 11 registers definition information defining items of monitoring target information in an operation system. Here, the monitoring target information is, for example, setting information, setting files, log files, and inventory files including the execution results (for example, lists of statuses) of the predetermined status acquisition commands for the monitoring target device. The monitoring target information contains values corresponding to one or more items. Here, the item can be referred to as an attribute or a parameter. The definition information is associated with the monitoring target device, information for acquiring the monitoring target information (monitoring target acquisition information), and item information. The item information may be, for example, a character string indicating an item name, an attribute name, and a parameter name. The registration unit 11 registers the definition information by storing it in an internal storage device of the operation management apparatus 1 or in an external storage device connected to the operation management apparatus 1.

Based on the definition information, the generation unit 12 generates an expected value table and an actual setting value table each including a column corresponding to an item. The expected value table and the actual setting value table include definitions of common columns corresponding to items. For example, the expected value table and the actual setting value table include the same column name corresponding to a specific item.

The storage unit 13 stores the expected value corresponding to the item input from the outside in the column corresponding to the item in the expected value table. The expected value is the value that the setting value in the monitoring target device should be. The expected value is, for example, a predetermined value based on a requirement for the operation system or the like. In addition, the storage unit 13 stores the actual setting value corresponding to the item contained in the monitoring target information acquired from the operation system in the column corresponding to the item in the actual setting value table. Note that the storage unit 13 may acquire the actual setting value itself. Alternatively, the storage unit 13 may acquire monitoring target information from the operation system and acquire the actual setting value corresponding to the item from the acquired monitoring target information. The determination unit 14 compares the expected value with the actual setting value based on the definition information, and determines whether they match or not. That is, the determination unit 14 compares the expected value stored in the column corresponding to the specific item in the expected value table with the actual setting value stored in the column corresponding to the same item in the actual setting value table.

In a case where the expected value does not match the actual setting value, the instruction unit 15 performs an update instruction for the operation system from the actual setting value to the expected value. For example, the instruction unit 15 may issue an update command to the expected value for the corresponding item to the monitoring target device that is the acquisition source of the monitoring target information. In addition, the instruction unit 15 may transmit the monitoring target information in which the item is set to the expected value to the monitoring target device and have it overwritten.

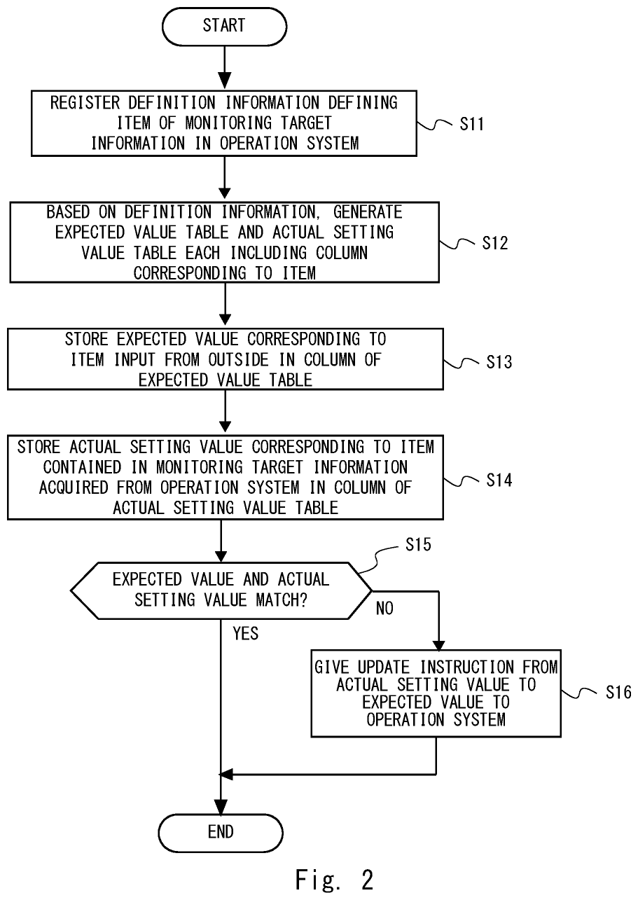

FIG. 2 is a flowchart illustrating a flow of an operation management method according to the first example embodiment. First, the registration unit 11 registers definition information defining items of monitoring target information in an operation system (S11). For example, the registration unit 11 receives the definition information from the terminal of the operation manager and stores the definition information in a predetermined storage device. Next, based on the definition information, the generation unit 12 generates an expected value table and an actual setting value table each including a column corresponding to the item (S12). For example, the generation unit 12 generates an expected value table and an actual setting value table in a database in the storage device.

The storage unit 13 stores the expected value corresponding to the item input from the outside in the column corresponding to the item in the expected value table (S13). For example, the storage unit 13 receives an input of an expected value from the terminal of the operation manager, and registers the received expected value as the value of the column in the expected value table.

The storage unit 13 stores the actual setting value corresponding to the item contained in the monitoring target information acquired from the operation system in the column corresponding to the item in the actual setting value table (S14).

Then, the determination unit 14 determines whether the expected value matches the actual setting value (S15). That is, the determination unit 14 compares the values stored in the corresponding columns of the expected value table and the actual setting value table to determine whether they match or not. In a case where the expected value and the actual setting value match, the process is terminated.

On the other hand, in a case where it is determined in Step S15 that the expected value and the actual setting value do not match, the instruction unit 15 performs an update instruction for the operation system from the actual setting value to the expected value (S16).

As described above, in the present example embodiment, the item level of the monitoring target information is defined in advance, and two tables having common columns are generated based on the definition information. The expected value of the item is stored in the corresponding column of one expected value table, and the latest actual setting value acquired from the operation system is stored in the corresponding column of the other actual setting value table. Then, the values of the corresponding columns of the tables are compared with each other. In a case where the values do not match, the update is performed according to the expected value.

In this manner, by matching the configurations of the columns between the expected value table and the actual setting value table, comparison processing between the expected value and the actual setting value to be performed later can be facilitated. In addition, since the operation management apparatus automatically generates the expected value table and the actual setting value table in which the configurations of the columns correspond to each other, the complexity of setting by the operation manager is reduced. Then, the mismatch between the expected value and the actual setting value can then be properly detected so that the operation system can be updated and repaired according to the expected value. Therefore, the present example embodiment can perform efficient setting for system monitoring, abnormality detection, and repair.

Note that the operation management apparatus 1 includes a processor, a memory, and a storage device as components (not illustrated). In addition, the storage device stores a computer program in which the processing of the operation management method according to the present example embodiment is implemented. Then, the processor reads the computer program from the storage device into the memory and executes the computer program. As a result, the processor implements the functions of the registration unit 11, the generation unit 12, the storage unit 13, the determination unit 14, and the instruction unit 15.

Alternatively, each of the registration unit 11, the generation unit 12, the storage unit 13, the determination unit 14, and the instruction unit 15 may be implemented by dedicated hardware. In addition, some or all of the components of each device may be implemented by, for example, a general-purpose or dedicated circuitry, a processor, or a combination thereof. These may be configured by a single chip or may be configured by a plurality of chips that are connected to each other through a bus. Some or all of the components of each device may be implemented by, for example, a combination of the above-described circuit and a program. Furthermore, for example, a central processing unit (CPU), a graphics processing unit (GPU), a field-programmable gate array (FPGA), or a quantum processor (quantum computer control chip) can be used as the processor.

Furthermore, in a case where some or all of the components of the operation management apparatus 1 are implemented by a plurality of information processing devices, circuits, and the like, the plurality of information processing devices, circuits, and the like may be arranged in a centralized manner or in a distributed manner. For example, the information processing device, the circuit, and the like may be implemented as a form, such as a client-server system or a cloud computing system, in which each device is connected through a communication network. Furthermore, the function of the operation management apparatus 1 may be provided in a software as a service (SaaS) format.

### Second Example Embodiment

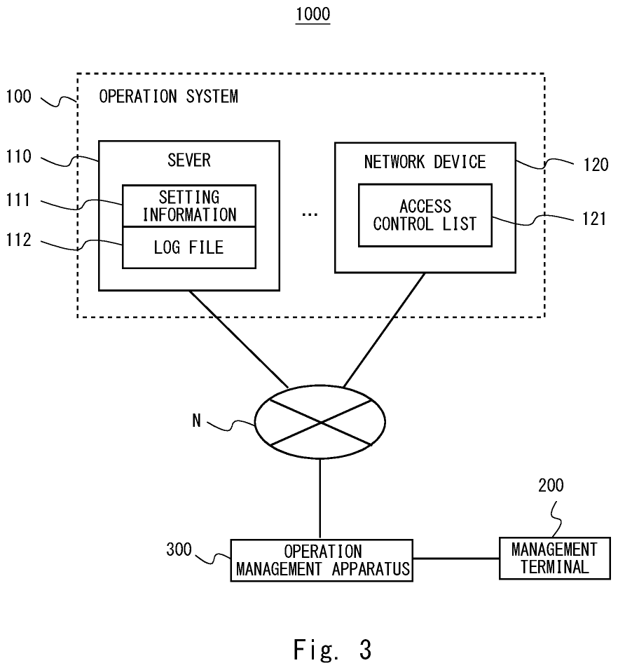

A second example embodiment is a specific example of the first example embodiment described above. FIG. 3 is a block diagram illustrating an overall configuration of an operation management system 1000 according to the second example embodiment. The operation management system 1000 includes an operation system 100, an operation management apparatus 300, and a management terminal 200. The operation system 100 and the operation management apparatus 300 are connected via at least a network N. Here, the network N is a communication network such as the Internet or a dedicated line.

The operation system 100 may be the above-described service providing system, a business system within a company, or the like. The operation system 100 should include at least one or more monitoring target devices such as a computer server, a network device, and a storage device, and be capable of acquiring monitoring target information from the operation management apparatus 300. Furthermore, the operation system 100 may be connected to an external system (not illustrated). The operation system 100 includes, for example, a gateway (GW) server, a firewall (FW), a web server, an application (AP) server, a database (DB) server, a router, a switch, a storage device, and the like. However, the configuration of the operation system 100 is not limited thereto. In addition, the connection relationship between the configurations within the operation system 100 are not particularly limited.

FIG. 3 illustrates a server 110 and a network device 120 as a part of the configuration of the operation system 100. The server 110 is an example of the computer server described above, and shall run an operating system (OS), middleware, an application, and the like. Alternatively, the server 110 may be a storage device. The server 110 includes setting information 111 and a log file 112. The setting information 111 is a setting file of an OS, middleware, an application, or the like. Alternatively, the setting information 111 is not limited to a file, and may be an execution result by various status acquisition commands. The log file 112 is a file in which log information output by an OS, middleware, an application, or the like is recorded. The network device 120 is an example of a router, a switch, and the like. The network device 120 includes, for example, an access control list 121. The access control list 121 is definition information for controlling communication accesses to be relayed. The access control list 121 is an example of setting information and a setting file. That is, the setting information 111, the log file 112, and the access control list 121 are examples of the monitoring target information, and are information including one or more items (attribute and parameter) and an actual setting value (attribute value and parameter value) corresponding to the item.

The management terminal 200 is a terminal device used by the operation manager in the operation of the operation work, and is, for example, a personal computer or the like. The management terminal 200 is communicably connected to the operation management apparatus 300 via a network or the like. The management terminal 200 receives inputs of the monitoring target connection information, the definition information, the setting file template, the expected value, the repair definition information, the workflow definition information, and the information of the tool group according to the operation by the operation manager, and transmits these to the operation management apparatus 300 for registration.

The operation management apparatus 300 is an example of the operation management apparatus 1 described above. The operation management apparatus 300 is an information processing device that performs registration of various kinds of definition information and expected values, a monitoring instruction to the monitoring target device, generation of an expected value table and an actual setting value table, registration of actual setting values of the monitoring target device, difference comparison between the expected value and the actual setting values, a repair instruction (update instruction) to the monitoring target device, and the like. The operation management apparatus 300 may be redundant in a plurality of servers, and each functional block may be implemented by a plurality of computers.

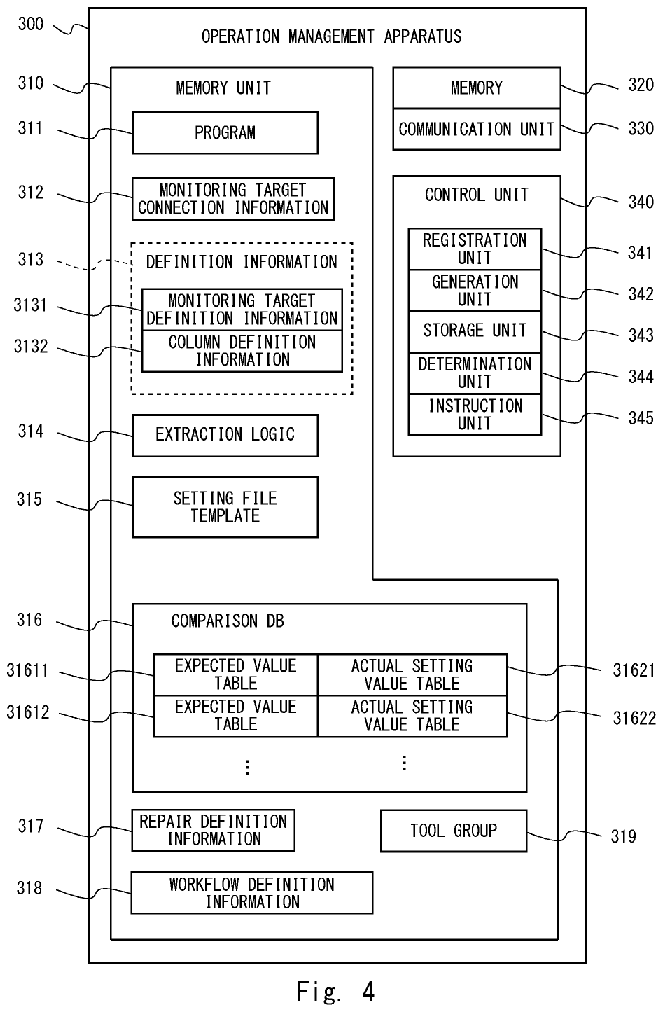

FIG. 4 is a block diagram illustrating a configuration of the operation management apparatus 300 according to the second example embodiment. The operation management apparatus 300 includes a memory unit 310, a memory 320, a communication unit 330, and a control unit 340. The memory unit 310 is an example of a storage device such as a hard disk, a flash memory, or a solid state drive (SSD). The memory unit 310 stores a program 311, monitoring target connection information 312, definition information 313, an extraction logic 314, a setting file template 315, a comparison DB 316, repair definition information 317, workflow definition information 318, and a tool group 319. The program 311 is a computer program in which the processing of the operation management method according to the second example embodiment is implemented.

Monitoring target connection information 312 is information on the monitoring target device, and particularly contains connection information to the monitoring target device. The connection information contains, for example, a device name (machine name, host name, etc.), an Internet Protocol (IP) address, an ID and a password of a login user. In addition, the monitoring target connection information 312 may contain a response status (response result) of the monitoring target device to the monitoring.

The definition information 313 is an example of the definition information according to the first example embodiment described above, and contains monitoring target definition information 3131 and column definition information 3132. The monitoring target definition information 3131 is information that defines monitoring target information and a table name that stores an expected value and an actual setting value of each item of the monitoring target information. That is, the monitoring target definition information 3131 contains a set of table names of the expected value table and the actual setting value table in the monitoring target information. The column definition information 3132 is information defining a column name of each item of the monitoring target information. That is, the definition information 313 may contain definitions of two or more items.

The extraction logic 314 is information defining an extraction rule and analysis process for extracting an actual setting value corresponding to each item from the monitoring target information. The extraction logic 314 may be a program module in which the analysis and extraction process is implemented or information defining a rule of the analysis and extraction process.

The setting file template 315 is information defining a template of a setting file such as the setting information 111 and the access control list 121. In the setting file template 315, the setting point of a setting value of each item is defined. That is, the setting file template 315 contains information in which an item and a setting point of a setting value are associated with each other.

The comparison DB 316 is a database that manages a set of an expected value table and an actual setting value table for each piece of monitoring target information. For example, an expected value table 31611 and an actual setting value table 31621 correspond to the first monitoring target information, and an expected value table 31612 and an actual setting value table 31622 correspond to the second monitoring target information. The expected value table 31611 is a table in which identification information (monitoring ID) of monitoring target information and item names (parameter name and attribute name) of one or more items are defined as column names. The actual setting value table 31621 is a table definition similar to the expected value table 31611. The actual setting value table 31621 and the actual setting value table 31622 have similar table definitions.

The repair definition information 317 is definition information in which a repair workflow is associated with each monitoring ID and column name (and actual setting value). The repair workflow is a set of a series of repair process for repairing a predetermined item in the monitoring target information of the monitoring target device to an expected value in a case where the expected value and the actual setting value do not match. The repair workflow may be referred to as an update workflow or a build workflow.

The workflow definition information 318 is information that defines a set of work (processes) for a repair (update or build) workflow. Each work is associated with one or more repair tools.

The tool group 319 is the entity of each tool defined by the workflow definition information 318. The tools are commands, instructions, programs, or the like that instruct the monitoring target device to be repaired to perform repair processing from the operation management apparatus 300. Note that the work and tools are examples of a plurality of processes for the operation system 100.

The memory 320 is a volatile storage device, such as a random access memory (RAM), and is a storage area for temporarily holding information during the operation of the control unit 340. The communication unit 330 is a communication interface with the network N.

The control unit 340 is a processor that controls each component of the operation management apparatus 300, that is, a control device. The control unit 340 reads the program 311 from the memory unit 310 into the memory 320 and executes the program 311. As a result, the control unit 340 implements the functions of a registration unit 341, a generation unit 342, a storage unit 343, a determination unit 344, and an instruction unit 345.

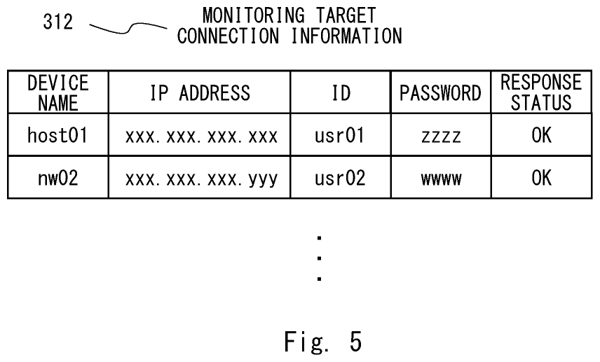

The registration unit 341 is an example of the registration unit 11 described above. The registration unit 341 receives the monitoring target connection information from the management terminal 200, and registers the monitoring target connection information 312 in the memory unit 310. FIG. 5 is a diagram illustrating an example of the monitoring target connection information 312 according to the second example embodiment. At the time of initial registration, the response status is not set. The registration unit 341 may further receive a monitoring schedule (a monitoring time, an interval, or the like) of each monitoring target device from the management terminal 200, and add the monitoring schedule to the monitoring target connection information 312.

The registration unit 341 receives monitoring target definition information and column definition information from the management terminal 200, and registers the monitoring target definition information 3131 and the column definition information 3132 in the memory unit 310. At the time of initial registration, the expected value table name and the actual setting value table name of the monitoring target definition information 3131 are not set. Then, the registration unit 341 adds a set of table names of the expected value table and the actual setting value table generated by the generation unit 342 to the monitoring target definition information 3131. In addition, the registration unit 341 may issue a monitoring ID at the time of initial registration, and set a common monitoring ID in the monitoring target definition information 3131 and the column definition information 3132.

In addition, the registration unit 341 may receive the extraction logic from the management terminal 200 and register the extraction logic 314 in the memory unit 310. In addition, the registration unit 341 receives the setting file template 315, the repair definition information 317, the workflow definition information 318, and the tool group 319 from the management terminal 200, and registers them in the memory unit 310.

The generation unit 342 is an example of the generation unit 12 described above. Based on the column definition information 3132, the generation unit 342 generates an expected value table and an actual setting value table each including a column name corresponding to an item. For example, it is assumed that two items (column names) are defined in a certain monitoring ID of the column definition information 3132. In this case, the generation unit 342 generates the expected value table 31611 and the actual setting value table 31621 in which a first column (column name) corresponding to the first item and a second column (column name) corresponding to the second item are included in the comparison DB 316. In addition, the generation unit 342 may further generate the extraction logic 314 that extracts the actual setting value corresponding to the item from the monitoring target information on the basis of the monitoring target definition information 3131 and the column definition information 3132. In this case, the registration unit 341 registers the generated extraction logic 314 in the memory unit 310.

The storage unit 343 is an example of the storage unit 13 described above. The storage unit 343 receives an expected value corresponding to a predetermined item in predetermined monitoring target information from the management terminal 200, and stores the received expected value in a column of a corresponding expected value table based on the monitoring target definition information 3131 or the column definition information 3132. Note that the storage unit 343 may acquire the expected value of the corresponding item from the requirement definition information, the specification information, or the configuration information in the monitoring target device of the operation system 100, and store the expected value in the corresponding column of the expected value table. For example, the storage unit 343 may acquire an expected value from a configuration management DB (not illustrated).

In addition, the storage unit 343 stores an actual setting value corresponding to an item contained in the monitoring target information acquired from a predetermined monitoring target device of the operation system 100 in the column corresponding to the item in the actual setting value table. For example, the storage unit 343 extracts the actual setting value from the monitoring target information acquired from the operation system 100 using the extraction logic 314, and stores the extracted actual setting value in the column corresponding to the item in the actual setting value table.

For example, it is assumed that two items (column names) are defined in a certain monitoring ID of the column definition information 3132. In this case, the storage unit 343 stores the first expected value corresponding to the first item in the first column in the actual setting value table, and stores the second expected value corresponding to the second item in the second column in the actual setting value table. In addition, the storage unit 343 stores the first actual setting value corresponding to the first item in the first column in the actual setting value table, and stores the second actual setting value corresponding to the second item in the second column in the actual setting value table.

The determination unit 344 is an example of the determination unit 14 described above. The determination unit 344 identifies the expected value table and the actual setting value table to be compared based on the set of table names of the monitoring target definition information 3131. Then, the determination unit 344 compares the expected value stored in the specific column in the identified expected value table with the actual setting value stored in the column common to the above in the identified actual setting value table. Then, the determination unit 344 determines whether the expected value and the actual setting value match for each column or not by the comparison. That is, the determination unit 344 may detect that the expected values of some columns match the actual setting values, but the expected values of other columns do not match the actual setting values.

The instruction unit 345 is an example of the instruction unit 15 described above. The instruction unit 345 performs a monitoring instruction to each monitoring target device based on the monitoring target connection information 312 and the monitoring target definition information 3131. For example, in the monitoring schedule contained in the monitoring target connection information 312, the instruction unit 345 may perform an instruction to acquire the monitoring target information using the monitoring target acquisition information in the monitoring target definition information 3131. Further, the instruction unit 345 may include the extraction logic 314 corresponding to the specific monitoring ID in the monitoring instruction.

In a case where the determination unit 344 determines that the expected value and the actual setting value do not match, the instruction unit 345 selects a process from among a plurality of processes for the operation system 100 according to the column in which the expected value and the actual setting value do not match, and executes the process to perform an update instruction. The instruction unit 345 may select a process according to the column further on the basis of the actual setting value. Specifically, the instruction unit 345 identifies a repair workflow from the repair definition information 317 on the basis of the monitoring ID and the column name (and the actual setting value) determined by the determination unit 344 that the expected value and the actual setting value do not match. Then, the instruction unit 345 executes the corresponding tool group according to the order of each work defined in the identified repair workflow based on the workflow definition information 318. That is, the instruction unit 345 acquires the corresponding tool from the tool group 319, and executes each tool on the monitoring target device corresponding to the monitoring ID. At this time, the instruction unit 345 sets an expected value for at least a part of the tool, and performs an update instruction (repair instruction) based on the expected value in the monitoring target device.

Here, for example, it is assumed that two items (column names) are defined in a certain monitoring ID of the column definition information 3132. In this case, the determination unit 344 performs a first determination of comparing the first expected value with the first actual setting value and a second determination of comparing the second expected value with the second actual setting value. Then, in a case where it is determined in the second determination that they do not match, the instruction unit 345 performs an update instruction for the operation system from the second actual setting value to the second expected value based on the monitoring target information.

The instruction unit 345 may periodically monitor the communication status with each monitoring target device via the network N. Then, the registration unit 341 registers or updates “OK”, “NG”, or the like to the response status of the monitoring target connection information 312 according to the monitoring result of the communication status. For example, in a case where a monitoring target device with an unsatisfactory communication status is detected, the storage unit 343 registers “NG” in the response status corresponding to the device name of the monitoring target device in the monitoring target connection information 312. Then, in a case where the response status of the monitoring target connection information 312 of the corresponding monitoring target device is “NG” before issuing the update instruction (repair instruction), the instruction unit 345 suspends the correction instruction. Then, after a lapse of a certain period of time, the instruction unit 345 checks the response status again. In a case where it is “OK”, the instruction unit 345 performs an update instruction. Alternatively, in a case where the response status is “NG”, the instruction unit 345 may perform another correction instruction. For example, the instruction unit 345 may perform a process to restore communication with the relevant monitoring target device.

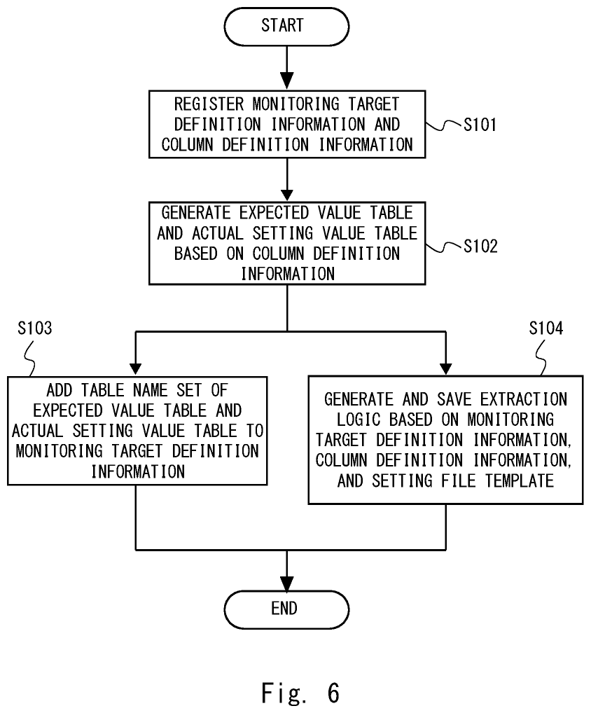

FIG. 6 is a flowchart illustrating a flow of a table generation process according to the second example embodiment. Here, it is assumed that the monitoring target connection information 312 has been registered. First, the registration unit 341 receives monitoring target definition information and column definition information from the management terminal 200, and registers the monitoring target definition information 3131 and the column definition information 3132 in the memory unit 310 (S101).

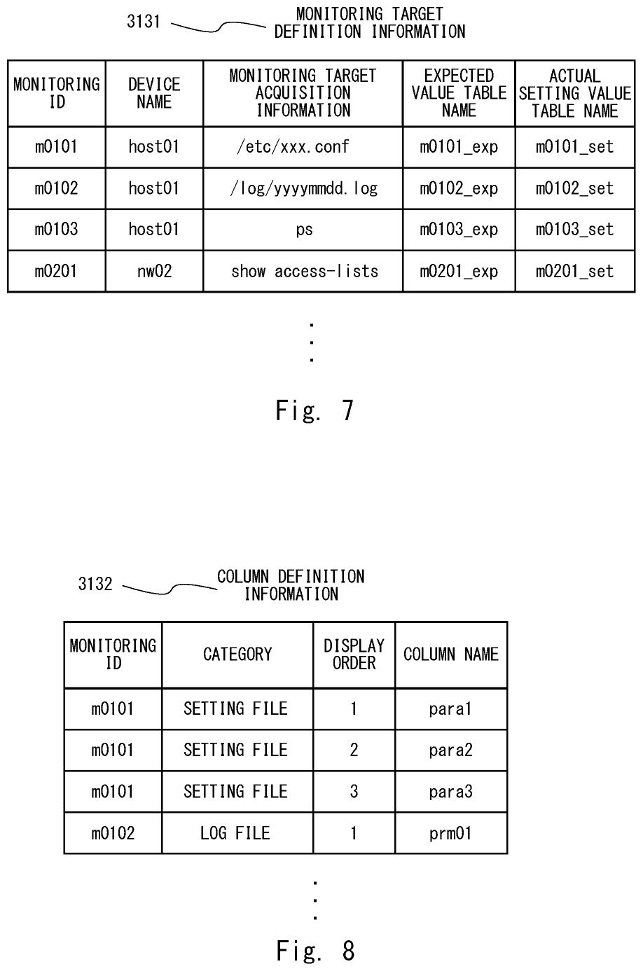

FIG. 7 is a diagram illustrating an example of the monitoring target definition information 3131 according to the second example embodiment. The monitoring target definition information 3131 contains a monitoring ID, a device name, monitoring target acquisition information, an expected value table name, and an actual setting value table name. The monitoring ID is identification information of monitoring target information. Therefore, a plurality of monitoring IDs may be defined per monitoring target device. Here, it is indicated that monitoring IDs “m0101”, “m0102”, and “m0103” are defined for the monitoring target device “host01”. The device name may be a host name of a server or the like. The monitoring target acquisition information is information used to acquire the monitoring target information. When the monitoring target information is a setting file or a log file, the monitoring target acquisition information is a directory path (and a file name) of a save location of the file. In addition, when the monitoring target information is a list of statuses of a device, an OS, middleware, and an application, the monitoring target acquisition information is (a path of) a status acquisition command. For example, in the case of monitoring IDs “m0101” and “m0102”, the monitoring target acquisition information indicates a directory path of the save location of the setting file and the log file. In addition, in the case of the monitoring IDs “m0103” and “m0201”, the monitoring target acquisition information indicates an OS startup process acquisition command “ps” and an access control list acquisition command “show access-lists”. Note that these pieces of monitoring target acquisition information are merely examples. The set of the expected value table name and the actual setting value table name may be a name set in the management terminal 200. Alternatively, the set of the expected value table name and the actual setting value table name may be generated by the registration unit 341 based on the monitoring ID at the time of initial registration. Alternatively, the set of the expected value table name and the actual setting value table name may be empty at the time of initial registration.

FIG. 8 is a diagram illustrating an example of the column definition information 3132 according to the second example embodiment. The column definition information 3132 contains a monitoring ID, a category, a display order, and a column name. The monitoring ID is information corresponding to the monitoring ID of the monitoring target definition information 3131. That is, monitoring target definition information 3131 and column definition information 3132 have a one-to-many relationship. However, the table configuration of the definition information 313 is not limited thereto.

The category is information indicating a category of the monitoring target information. The display order is information indicating the display order of the column name input field on the screen for inputting the column name of the monitoring target information in the management terminal 200. Therefore, in the column definition information 3132, the record is uniquely identified by a set of the monitoring ID, the category, and the display order. The column name is a character string of column names (attribute name and parameter name) corresponding to the items of the monitoring target information. Since the column name is a character string used at the time of table generation by the generation unit 342, it is assumed to be unique in the set of the monitoring ID and the category.

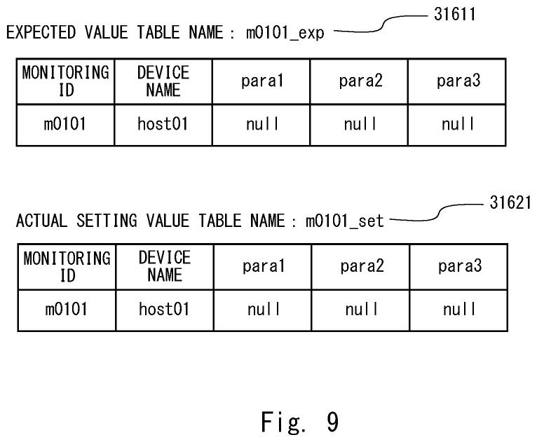

Returning to FIG. 6, the description will be continued. After Step S101, the generation unit 342 generates an expected value table and an actual setting value table based on the column definition information 3132 (S102). FIG. 9 is a diagram illustrating an example of an expected value table and an actual setting value table immediately after generation according to the second example embodiment. For example, the generation unit 342 determines an expected value table name “m0101_exp” and an actual setting value table name “m0101_set” from the monitoring ID “m0101” of the column definition information 3132 in FIG. 8. When the table name is set in advance as illustrated in FIG. 7, the generation unit 342 may acquire the expected value table name and the actual setting value table name from the monitoring target definition information 3131. In addition, the generation unit 342 identifies column names “para1”, “para2”, and “para3” associated with the monitoring ID “m0101” of the column definition information 3132. Then, the generation unit 342 generates new tables having the expected value table name “m0101_exp”, the column names “monitoring ID”, “device name”, “para1”, “para2”, and “para3” for the comparison DB 316. In addition, the generation unit 342 stores the initial record with the column order “m0101”, “host01”, “null”, “null”, and “null” in the expected value table name “m0101_exp”. Note that the storage unit 343 may store the respective expected values of “para1”, “para2”, and “para3” as initial records in response to the generation of the expected value table.

In addition, the generation unit 342 generates new tables having actual setting value table names “m0101_set”, column names “monitoring ID”, “device name”, “para1”, “para2”, and “para3” for the comparison DB 316. In addition, the generation unit 342 stores the initial record with the column order “m0101”, “host01”, “null”, “null”, and “null” in the expected value table name “m0101_exp”.

Returning to FIG. 6, the description will be continued. After Step S102, the registration unit 341 adds the set of table names of the expected value table and the actual setting value table generated in Step S102 to the monitoring target definition information 3131 (S103). In addition, the generation unit 342 generates the extraction logic 314 based on the monitoring target definition information 3131, the column definition information 3132, and the setting file template 315. Then, the registration unit 341 stores the generated extraction logic 314 in the memory unit 310 (S104).

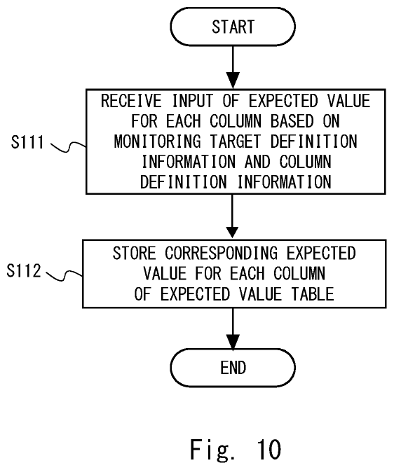

FIG. 10 is a flowchart illustrating a flow of the expected value storage process according to the second example embodiment. First, the storage unit 343 receives an input of an expected value corresponding to a predetermined item in predetermined monitoring target information from the management terminal 200 based on the monitoring target definition information 3131 and the column definition information 3132 (S111). For example, the storage unit 343 receives expected values “aaa”, “bbb”, and “ccc” in the items “para1”, “para2”, and “para3” of the setting file “/etc/xxx.conf” of the device name “host01”. Then, the storage unit 343 stores a corresponding expected value for each column of the expected value table (S112). For example, the storage unit 343 identifies the monitoring ID “m0101” and the expected value table name “m0101_exp” from the setting file “/etc/xxx.conf” of the device name “host01” based on the monitoring target definition information 3131. In addition, the storage unit 343 identifies the column names “para1”, “para2”, and “para3” from the monitoring ID “m0101” and the category “setting file” based on the column definition information 3132. Then, the storage unit 343 stores “aaa” in the column name “para1”, “bbb” in “para2”, and “ccc” in “para3” of “m0101_exp” in the identified expected value table 31611.

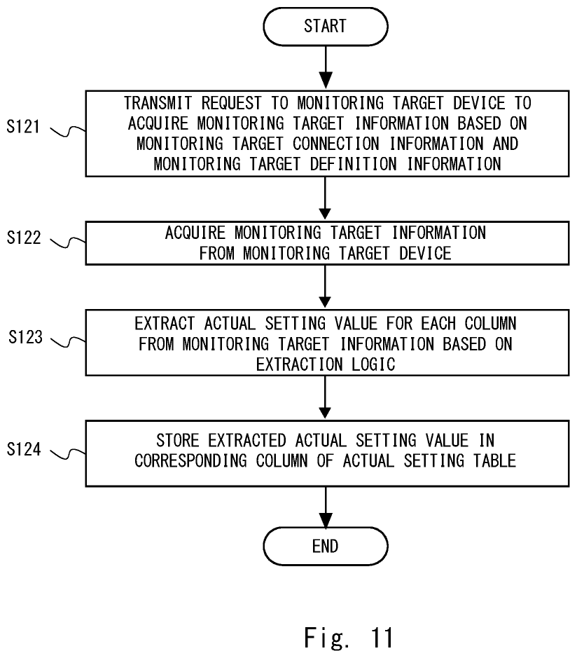

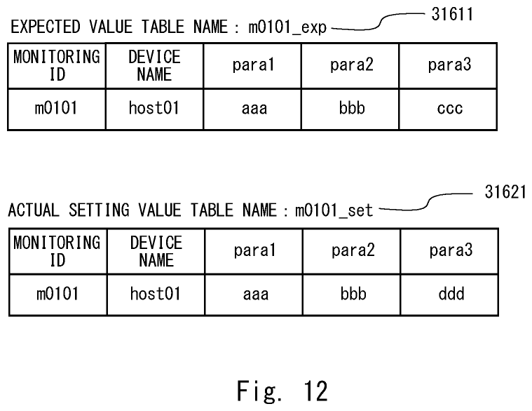

FIG. 11 is a flowchart illustrating a flow of an actual setting value storage process according to the second example embodiment. First, the instruction unit 345 transmits an acquisition request for monitoring target information to the monitoring target device based on the monitoring target connection information 312 and the monitoring target definition information 3131 (S121). For example, it is assumed that the monitoring target device is the server 110, the device name is “host01”, and the monitoring target information is the setting information 111 (setting file). In this case, instruction unit 345 acquires the IP address, ID, and password of device name “host01” from the monitoring target connection information 312. Then, the instruction unit 345 acquires “/etc/xxx.conf”, which is the monitoring target acquisition information associated with the acquired device name and setting file, from the monitoring target definition information 3131. Then, the instruction unit 345 transmits an acquisition request of “/etc/xxx.conf” to the server 110 using the IP address, the ID, and the password of “host01”. Alternatively, the instruction unit 345 may transmit an acquisition request for the setting information 111 to the server 110 in response to the designation of the monitoring ID “m0101”. Alternatively, the instruction unit 345 may perform the monitoring setting of the setting information 111 on the server 110 based on the monitoring schedule set in the monitoring target connection information 312.

In response to this, the server 110 returns the setting information 111 to the operation management apparatus 300. Therefore, the storage unit 343 acquires the monitoring target information from the monitoring target device (S122). For example, the storage unit 343 acquires the setting information 111 from the server 110. Then, the storage unit 343 extracts the actual setting value corresponding to each column from the monitoring target information based on the extraction logic 314 (S123). Specifically, the storage unit 343 analyzes the received setting information 111 based on the extraction logic 314 and extracts a value (actual setting value) corresponding to each column name (item). For example, the storage unit 343 extracts actual setting values “aaa”, “bbb”, and “ddd” in the items “para1”, “para2”, and “para3” of “/etc/xxx.conf”. Then, the storage unit 343 stores the extracted actual setting value in each corresponding column in the actual setting value table (S124). For example, the storage unit 343 stores the actual setting values “aaa”, “bbb”, and “ddd” in the column names “para1”, “para2”, and “para3” in “m0101” and “host01” of the actual setting value table 31621 “m0101 set”.

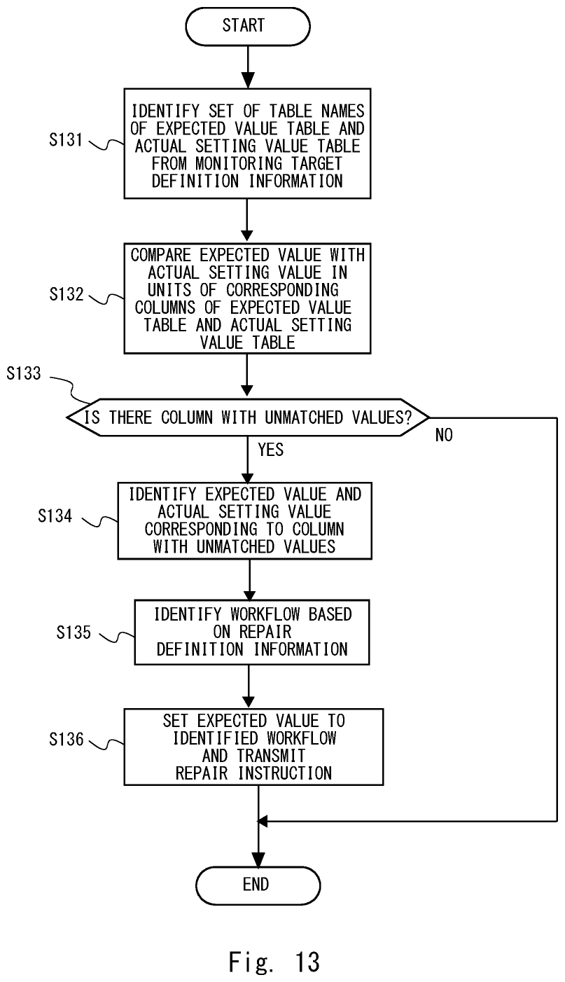

FIG. 12 is a diagram illustrating an example of the expected value table 31611 and the actual setting value table 31621 after value storage according to the second example embodiment. In this example, the value (expected value) of the column name “para3” in the expected value table 31611 is “ccc”, but the value (actual setting value) of the column name “para3” in the actual setting value table 31621 is “ddd”, indicating that they do not match.

FIG. 13 is a flowchart illustrating a flow of a difference detection and repair process according to the second example embodiment. For example, the determination unit 344 periodically starts the present processing. Alternatively, the determination unit 344 may start this process in response to an instruction from the management terminal 200. Alternatively, the determination unit 344 may start this process in a case where it detects that the expected value table has been updated.

When this process is started, the determination unit 344 first identifies a set of table names of the expected value table and the actual setting value table from the monitoring target definition information 3131 (S131). For example, the determination unit 344 identifies the table name to be determined as a set of the expected value table name “m0101_exp” and the actual setting value table 31621 “m0101 set”.

Next, the determination unit 344 compares the expected value with the actual setting value in units of corresponding columns of the expected value table and the actual setting value table (S132). For example, the determination unit 344 compares the expected value “aaa” stored in the column name “para1” of the expected value table name “m0101_exp” with the actual setting value “aaa” stored in the column name “para1” of the actual setting value table 31621 “m0101_set”. Similarly, the determination unit 344 compares the expected value “ccc” stored in the column name “para3” of the expected value table name “m0101_exp” with the actual setting value “ddd” stored in the column name “para3” of the actual setting value table 31621 “m0101 set”.

Then, the determination unit 344 determines whether there is a column in which the expected value and the actual setting value do not match in the comparison result or not (S133). In a case where there is no unmatched column (NO in S133), the process is terminated. On the other hand, in a case where there is a column in which the values do not match (YES in S133), Step S134 is executed. In the above example, the expected value and the actual setting value do not match in the column name “para3”.

Therefore, the instruction unit 345 identifies the expected value and the actual setting value corresponding to the column in which the values do not match (S134). For example, the instruction unit 345 identifies the expected value “ccc” from the column name “para3” of the expected value table 31611 “m0101_exp”. Further, the instruction unit 345 identifies the actual setting value “ddd” from the column name “para3” of the actual setting value table 31621 “m0101_set”.

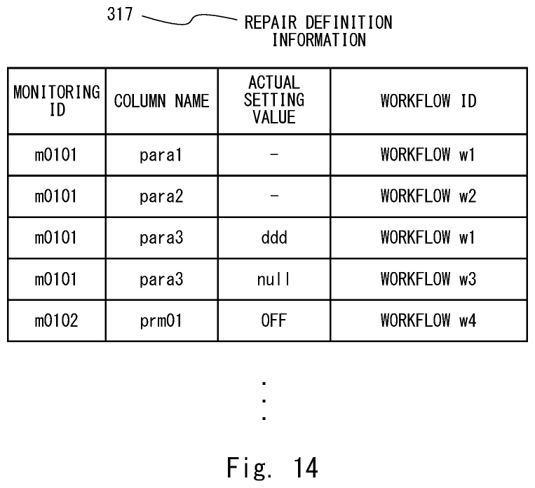

Then, the instruction unit 345 identifies the workflow based on the repair definition information 317 (S135). FIG. 14 is a diagram illustrating a configuration example of the repair definition information 317 according to the second example embodiment. Here, in each record of the repair definition information 317, the workflow ID of the repair workflow is uniquely identified by a set of the monitoring ID, the column name, and the actual setting value. However, the actual setting value is not necessarily required in the repair definition information 317. Therefore, in the repair definition information 317, the workflow ID may be uniquely identified by at least a set of the monitoring ID and the column name. Here, the instruction unit 345 identifies the workflow w1 associated with the monitoring ID “m0101”, the column name “para3”, and the actual setting value “ddd”.

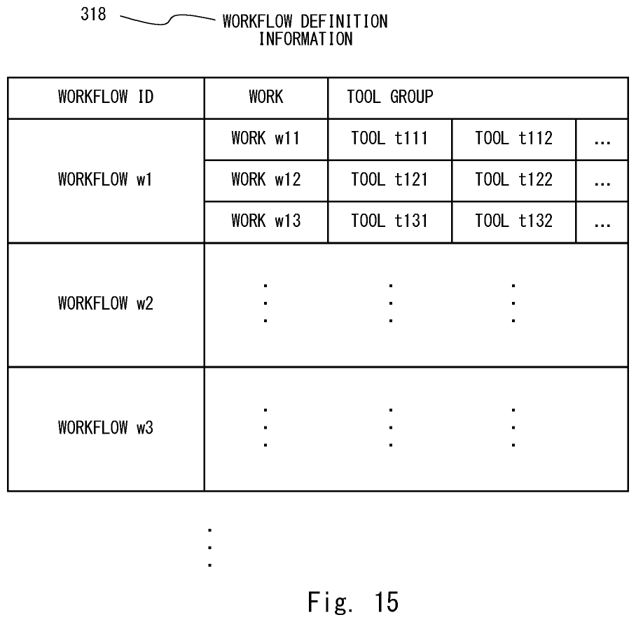

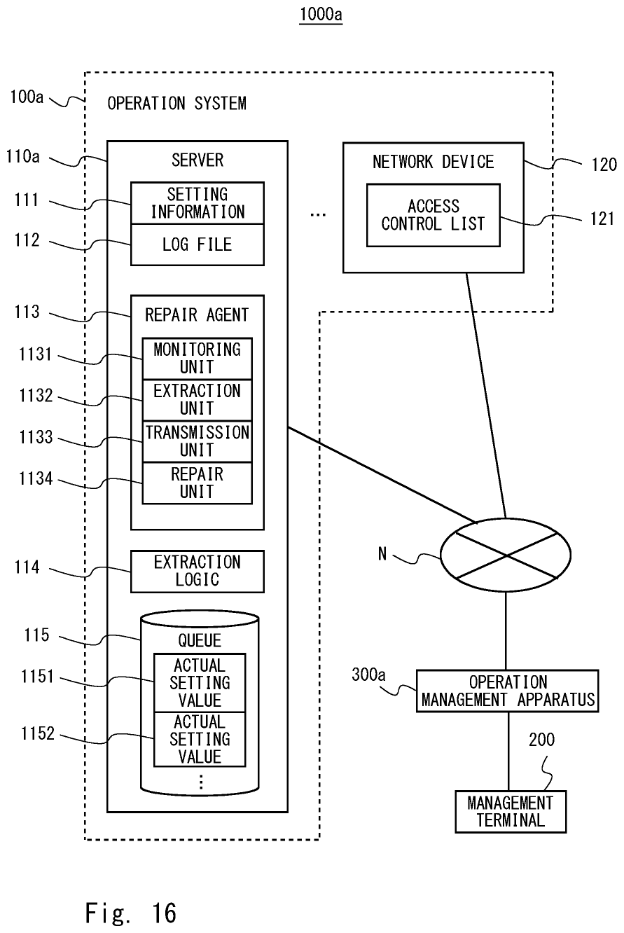

FIG. 15 is a diagram illustrating a configuration example of the workflow definition information 318 according to the second example embodiment. In the workflow definition information 318, one or more works (work IDs) are associated with a workflow ID, and one or more tool IDs are associated with each work ID. For example, the works w11, w12, and w13 are associated with the workflow w1. Preferably, the work w11 is a pre-processing for repair and update, the work w12 is a repair and update process based on an expected value, and the work w13 is post-processing. In addition, tools t111, t112 . . . are associated with the work w11. The tool t111 and the like are identification information of a tool (execution program, command, and the like) stored in the tool group 319.

Returning to FIG. 13, the description will be continued. After Step S135, the instruction unit 345 sets an expected value to the identified workflow and transmits a repair instruction to the monitoring target device (S136). For example, the instruction unit 345 acquires a tool (pre-processing) corresponding to the tool t111 associated with the work w11 from the tool group 319, and executes the tool using the connection information of the server 110. As a result, the server 110 executes pre-processing corresponding to the tool till via the network N. Subsequently, the instruction unit 345 acquires a tool (pre-processing) corresponding to the tool t112 associated with the work w11 from the tool group 319, and executes the tool using the connection information of the server 110. Thereafter, similarly, the instruction unit 345 executes a tool related to pre-processing.

Next, the instruction unit 345 acquires a tool (repair/update process) corresponding to the tool t121 associated with the work w12 from the tool group 319, sets an expected value “ccc” for the tool, and executes the tool using the connection information of the server 110. In response to this, the server 110 updates the actual setting value of “para3” in the setting information 111 to the expected value “ccc” via the network N.

Thereafter, the instruction unit 345 acquires a tool (post-processing) corresponding to the tool t131 associated with the work w13 from the tool group 319, and executes the tool using the connection information of the server 110. As a result, the server 110 executes the post-processing corresponding to the tool t131 via the network N.

As a result, the incorrect actual setting value of the predetermined item in the setting information 111 of the server 110 can be updated (repaired) to the expected value. That is, in a case where the actual setting value of each item of the monitoring target information in the operation system is different from the expected value, it can be automatically repaired. Therefore, daily maintenance operation can be greatly reduced.

Note that the operation management system 1000 according to the present example embodiment can flexibly cope with various monitoring target devices and monitoring target information. Examples of these are given below. First, it is assumed that the monitoring target information is a process running in the server 110 included in the operation system 100. Then, it is assumed that the determination unit 344 determines that the actual setting value indicates that the process has not been started. In this case, the instruction unit 345 may select a first process of restarting the process, and execute the first process to perform an update instruction. For example, the monitoring target acquisition information is a ps command, the storage unit 343 acquires the execution result of the ps command from the server 110, and extracts whether the WEB server process is started or not from the execution result. For example, in a case where the WEB server process has not been started, the storage unit 343 may extract the fact that the WEB server process does not exist (null) from the execution result. In this case, the storage unit 343 stores the actual setting value “null” in the column corresponding to the startup state of the WEB server process in the actual setting value table. On the other hand, since the expected value of the startup state of the process is “on” or “httpd”, the determination unit 344 determines that the expected value of the column corresponding to the startup state of the process does not match the actual setting value. Therefore, the instruction unit 345 identifies the workflow for restarting the WEB server process according to the monitoring ID, the column name, and the actual setting value “null”, and performs a repair instruction. As a result, the present disclosure can be applied not only to the monitoring of the setting value but also to the monitoring of the process.

Furthermore, in the above description, it is assumed that the execution of the first process has failed. In this case, the instruction unit 345 may further select a second process of installing the execution file corresponding to the process on the corresponding server and executing the execution file, and execute the second process to perform an update instruction. For example, in a case where the restart of the WEB server process by the above repair instruction fails, the instruction unit 345 installs the WEB server installation module in the server 110. Then, the instruction unit 345 instructs the server 110 to start the WEB server process after installation. As a result, even in a case where the execution file is deleted due to some failure, the rebuilding of the server including middleware can be automated.

In addition, it is assumed that the monitoring target information is a setting file in the server 110 included in the operation system 100. Then, it is assumed that the determination unit 344 determines that the actual setting value indicates that the setting file does not exist. In this case, the instruction unit 345 selects a third process of generating a setting file, in which an expected value is set, and saving the generated configuration file in the server 110. Then, the instruction unit 345 executes the third process to perform an update instruction. As a result, even in a case where the setting file is deleted due to some failure or operation error, it can be repaired by automatically relocating the configuration file with the correct expected values.

In addition, it is assumed that the monitoring target information is a valid port for the network in the server 110 included in the operation system 100. Then, it is assumed that the determination unit 344 determines that the actual setting value indicates that other port than the port is valid. In this case, the instruction unit 345 selects a fourth process of disabling the other port for the server 110, and executes the fourth process to perform an update instruction. As a result, the system can detect cases such as when a port is unexpectedly opened by software installed in the server 110 for a repair work or the like, and can automatically repair the port.

In addition, it is assumed that the monitoring target information is the access control list 121 of the network device 120 included in the operation system 100. Then, it is assumed that the determination unit 344 determines that the actual setting value does not match the setting information of the access control list 121 indicated by the expected value. In this case, the instruction unit 345 selects a fifth process of generating an access control list, in which an expected value is set, and saving the generated access control list in the network device 120. Then, the instruction unit 345 executes the fifth process to perform an update instruction. As a result, not only the setting information of the server but also the setting information of the network device 120 can be automatically repaired.

### Third Example Embodiment

A third example embodiment is a modified example of the second example embodiment. At least a part of the monitoring target device included in an operation system 100a according to the third example embodiment is operated by a repair agent that operates in cooperation with the operation management apparatus. The repair agent monitors the monitoring target device, acquires the monitoring target information, extracts actual setting values, and transmits the actual setting values to the operation management apparatus.

FIG. 16 is a block diagram illustrating an overall configuration of an operation management system 1000a according to the third example embodiment. The operation management system 1000a includes an operation system 100a, an operation management apparatus 300a, and a management terminal 200. The operation system 100a and the operation management apparatus 300a are connected via at least a network N.

The operation system 100a includes a server 110a and a network device 120. The server 110a and the network device 120 are examples of monitoring target devices. The server 110a includes a repair agent 113, an extraction logic 114, and a queue 115 in addition to the function and configuration of the server 110 of the second example embodiment described above.

The repair agent 113 is a software program that monitors monitoring target information containing the setting information 111 and the log file 112 and repairs the monitoring target information in response to a repair instruction from the operation management apparatus 300a. The control unit (not illustrated) of the server 110a loads into a memory and executes the program in which the functions of the repair agent 113 are implemented. As a result, the control unit implements the functions of the repair agent 113.

The repair agent 113 includes a monitoring unit 1131, an extraction unit 1132, a transmission unit 1133, and a repair unit 1134. The monitoring unit 1131 performs monitoring setting in in response to a monitoring instruction from the operation management apparatus 300a via the network N. For example, the monitoring unit 1131 sets the monitoring target acquisition information and the monitoring schedule for acquiring the monitoring target information (the setting information 111 and the log file 112). In addition, the monitoring unit 1131 acquires the extraction logic included in the monitoring instruction and stores it as the extraction logic 114 in a storage device (not illustrated). Then, the monitoring unit 1131 acquires the monitoring target information using the monitoring target acquisition information according to the monitoring instruction or the monitoring schedule.

The extraction unit 1132 extracts the actual setting value corresponding to the item from the acquired monitoring target information using the extraction logic 114. Note that the extraction unit 1132 may perform the process similar to the extraction process by a storage unit 343 according to the second example embodiment described above.

The transmission unit 1133 transmits the acquired actual setting value to the operation management apparatus 300a via the network N.

The repair unit 1134 updates (repairs) the actual setting value corresponding to the corresponding item to the expected value in response to the update instruction (restoration instruction) received from the operation management apparatus 300a via the network N.

The extraction logic 114 is information similar to the extraction logic 314 of the second example embodiment described above. That is, the extraction logic 114 is information generated or set on the operation management apparatus 300a side and stored in the server 110a.

The queue 115 is a storage area that stores and outputs untransmitted actual setting values in a FIFO (First In First Out) fashion. The queue 115 illustrates an example in which the actual setting values 1151, 1152, . . . are stored in this order. In this case, the queue 115 outputs the actual setting values 1151, 1152, . . . in this order according to the storage order.

Here, in a case where the communication with the operation management apparatus 300a is not available, the transmission unit 1133 stores the actual setting values in the queue 115, and transmits the actual setting values to the operation management apparatus 300a in accordance with the queue 115 after the communication with the operation management apparatus 300a is restored.

The network device 120 is similar to that in the second example embodiment described above. However, similarly to the server 110a, the network device 120 may include a repair agent, extraction logic, and a queue.

Since the operation management apparatus 300a has the same configuration as the operation management apparatus 300 according to the second example embodiment described above, illustration and redundant description thereof will be omitted. An instruction unit 345 of the operation management apparatus 300a according to the third example embodiment includes the extraction logic 314 when performing a monitoring instruction to the server 110a. In a case where the storage unit 343 receives an actual setting value from the repair agent 113, it stores the received actual setting value in the column corresponding to the item in the actual setting value table. Note that, in a case where the monitoring target information is acquired from a monitoring target device (for example, the network device 120 or the like) that does not include a repair agent, the storage unit 343 extracts an actual setting value using the extraction logic 314 in the similar manner to that according to the second example embodiment described above. Then, the storage unit 343 stores the extracted actual setting value in the column corresponding to the item in the actual setting value table.

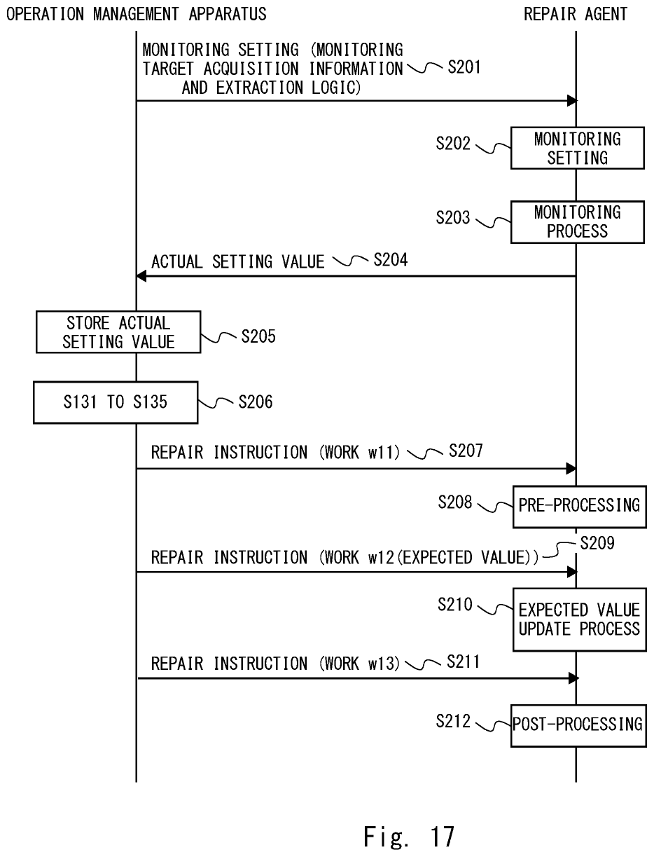

FIG. 17 is a sequence diagram illustrating a flow of the monitoring and repair process according to the third example embodiment. First, the instruction unit 345 of the operation management apparatus 300a performs a monitoring instruction to the repair agent 113 of the server 110a based on monitoring target connection information 312 and monitoring target definition information 3131 (S201). At this time, the instruction unit 345 includes the monitoring schedule, the monitoring target acquisition information, and the extraction logic 314 in the monitoring instruction.

In response to this, the monitoring unit 1131 of the repair agent 113 performs monitoring setting (S202). Specifically, the monitoring unit 1131 sets the setting information 111 and the log file 112 as the monitoring target information, and sets the save location of these files and the status acquisition commands. In addition, the monitoring unit 1131 sets a monitoring schedule. In addition, the monitoring unit 1131 stores the extraction logic 114 included in the monitoring instruction. Thereafter, the monitoring unit 1131 performs a monitoring process according to the monitoring schedule (S203).

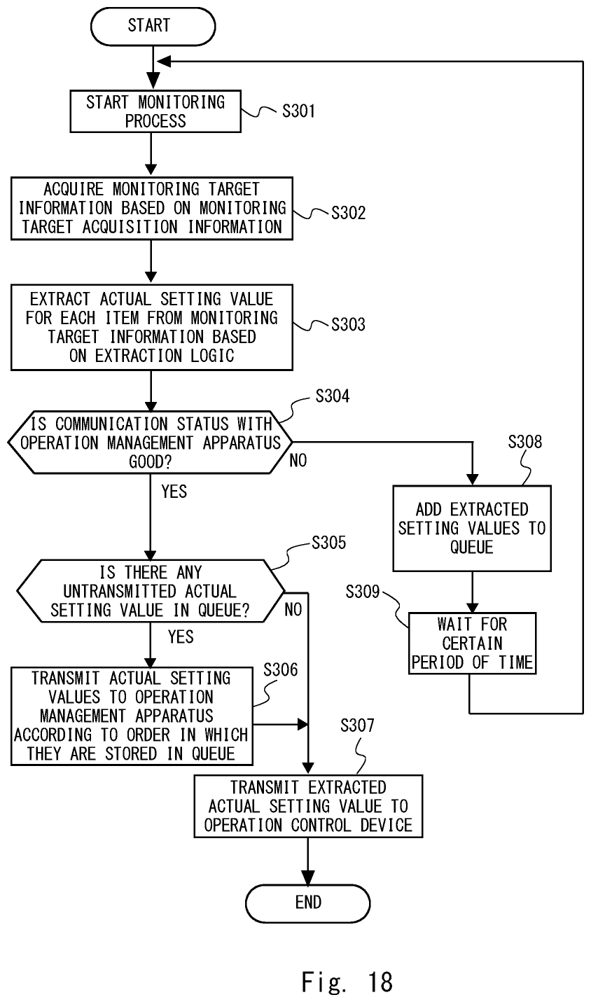

FIG. 18 is a flowchart illustrating a flow of a monitoring process in the repair agent 113 according to the third example embodiment. First, the repair agent 113 starts the monitoring process (S301). Then, the monitoring unit 1131 of the repair agent 113 acquires monitoring target information based on the monitoring target acquisition information (S302). For example, the monitoring unit 1131 acquires the setting file (/etc/xxx.conf) from the save location of the setting information 111. Then, the extraction unit 1132 extracts the actual setting value for each item from the monitoring target information based on the extraction logic 114 (S303). For example, it is assumed that the extraction unit 1132 extracts the values “aaa”, “bbb”, and “ddd” as the actual setting values corresponding to the items “para1”, “para2”, and “para3” of the setting file.

Then, the transmission unit 1133 determines whether the communication status with the operation management apparatus 300a is good or not (S304). For example, the transmission unit 1133 may determine that the communication status is good in a case where the normal response interval satisfies a predetermined condition by referring to the history of periodic communication checks with the operation management apparatus 300a via the network N. In a case where the communication status is determined to be good (YES in S304), the transmission unit 1133 determines whether there are any untransmitted actual setting values in the queue 115 or not (S305). In a case where it is determined that there is no untransmitted actual setting value in the queue 115 (NO in S305), the transmission unit 1133 transmits the actual setting value extracted in Step S303 to the operation management apparatus 300a via the network N (S307). At this time, the transmission unit 1133 transmits the corresponding item and the monitoring ID together with the actual setting value.

On the other hand, in a case where it is determined that there is an untransmitted actual setting value in the queue 115 (YES in S305), the transmission unit 1133 transmits the actual setting values 1151, 1152, . . . to the operation management apparatus 300a via the network N according to the order of storage in the queue 115 (S306). At this time, the transmission unit 1133 transmits the corresponding item and monitoring ID together with each actual setting value. Thereafter, the transmission unit 1133 executes Step S307.

In a case where it is determined in Step S304 that the communication status is not good (NO in S304), the transmission unit 1133 adds (stores) the actual setting value extracted in Step S303 to the queue 115 (S308). Note that the transmission unit 1133 may store the item and the monitoring ID corresponding to the actual setting value in the queue 115 in association with each other. Thereafter, the repair agent 113 waits for a certain period of time (S309). Then, the process returns to Step S301.

Note that after Step S309, the determination in Step S304 is performed again, and in a case where it is determined that the communication status is not good, the repair agent 113 may repeat waiting for a certain period of time. Alternatively, in a case where the communication status is determined to be good in the determination in Step S304 again, the transmission unit 1133 may transmit the actual setting value in the queue 115 in Step S306.

Returning to FIG. 17, the description will be continued. After Step S203, the storage unit 343 of the operation management apparatus 300a receives the actual setting value (and the corresponding item and monitoring ID) from the server 110a (S204). Then, the storage unit 343 stores the received actual setting value in each corresponding column in the actual setting value table (S205). For example, the storage unit 343 stores the actual setting values “aaa”, “bbb”, and “ddd” in the column names “para1”, “para2”, and “para3” in “m0101” and “host01” of the actual setting value table 31621 “m0101_set”. Thereafter, the operation management apparatus 300a executes Steps S131 to S135 in FIG. 13 described above. For example, it is assumed that it is determined in Step S133 that the expected value “ccc” of the column name “para3” and the actual setting value “ddd” do not match.

Then, the instruction unit 345 transmits a repair instruction for the work w11 to the repair agent 113 via the network N (S207). In response to this, the repair unit 1134 of the repair agent 113 performs pre-processing for repair (S208). Subsequently, the instruction unit 345 transmits a repair instruction for the work w12, in which the expected value “ccc” is set, to the repair agent 113 via the network N (S209). In response to this, the repair agent 113 performs an expected value update process for repair (S210). For example, the repair unit 1134 of the repair agent 113 updates the value of the item “para3” in the setting information 111 from “ddd” to “ccc”. Thereafter, the instruction unit 345 transmits a repair instruction for the work w13 to the repair agent 113 via the network N (S211). In response to this, the repair unit 1134 of the repair agent 113 performs post-processing for repair (S212).

As described above, similarly to the second example embodiment described above, according to the third example embodiment, the incorrect actual setting value of a predetermined item in the setting information 111 of the server 110 can be updated (repaired) to an expected value.

### Other Example Embodiments

Note that, in the above-described example embodiments, the configuration of the hardware has been described, but the present disclosure is not limited thereto. The present disclosure can also be implemented by causing a CPU to execute a computer program.

In the above example, the program may be stored using various types of non-transitory computer-readable media and supplied to a computer. The non-transitory computer-readable media include various types of tangible storage media. Examples of the non-transitory computer-readable media include a magnetic recording medium (for example, a flexible disk, a magnetic tape, or a hard disk drive), a magneto-optical recording medium (for example, a magneto-optical disc), a CD-read only memory (ROM), a CD-R, a CD-R/W, a digital versatile disc (DVD), and semiconductor memories (for example, a mask ROM, a programmable ROM (PROM), an erasable PROM (EPROM), a flash ROM, and a random access memory (RAM)). In addition, the program may be supplied to the computer by any of various types of transitory computer-readable media. Examples of the transitory computer-readable media include electrical signals, optical signals, and electromagnetic waves. The transitory computer-readable media can supply programs to computers via wired or wireless communication paths, such as wires and optical fiber.

Note that the present disclosure is not limited to the above example embodiments, and can be appropriately changed without departing from the gist. Furthermore, the present disclosure may be implemented by appropriately combining the respective example embodiments.

Some or all of the above-described example embodiments may be described as the following supplementary notes, but are not limited to the following.

(Supplementary Note A1)

An operation management apparatus including:
a registration unit configured to register definition information defining an item of monitoring target information in an operation system;
a generation unit configured to generate an expected value table and an actual setting value table each including a column corresponding to the item based on the definition information;
a storage unit configured to store an expected value corresponding to the item input from an outside in the column in the expected value table, and store an actual setting value corresponding to the item contained in the monitoring target information acquired from the operation system in the column in the actual setting value table;
a determination unit configured to compare the expected value with the actual setting value based on the definition information to determine whether the expected value and the actual setting value match or not; and
an instruction unit configured to perform an update instruction for the operation system from the actual setting value to the expected value in a case where the expected value does not match the actual setting value.

(Supplementary Note A2)

The operation management apparatus according to Supplementary Note A1, in which
the registration unit is configured to add a set of table names of the expected value table and the actual setting value table generated by the generation unit to the definition information, and
the determination unit is configured to identify the expected value table and the actual setting value table based on the set of table names, and compare the expected value stored in the column in the identified expected value table with the actual setting value stored in the column in the identified actual setting value table.

(Supplementary Note A3)

The operation management apparatus according to Supplementary Note A1 or A2, in which
the generation unit is configured to further generate an extraction logic that extracts the actual setting value corresponding to the item from the monitoring target information based on the definition information, and
the storage unit is configured to extract the actual setting value from the monitoring target information acquired from the operation system using the extraction logic, and store the extracted actual setting value in the column in the actual setting value table.

(Supplementary Note A4)

The operation management apparatus according to any one of Supplementary Notes A1 to A3, in which
the instruction unit is configured to select a process according to the column in which the expected value does not match the actual setting value from among a plurality of processes for the operation system, and execute the process to perform the update instruction.

(Supplementary Note A5)

The operation management apparatus according to Supplementary Note A4, in which
the instruction unit is configured to select a process according to the column further based on the actual setting value.

(Supplementary Note A6)

The operation management apparatus according to Supplementary Note A4 or A5, in which
in a case where the monitoring target information is a process that is running on a server included in the operation system and the actual setting value indicates that the process is not running, the instruction unit is configured to select a first process of restarting the process, and execute the first process to perform the update instruction.

(Supplementary Note A7)

The operation management apparatus according to Supplementary Note A6, in which
in a case where the execution of the first process fails, the instruction unit is configured to further select a second process of installing an execution file corresponding to the process in the server and executing the execution file, and execute the second process to perform the update instruction.

(Supplementary Note A8)

The operation management apparatus according to any one of Supplementary Notes A4 to A7, in which
in a case where the monitoring target information is a setting file in a server included in the operation system and the actual setting value indicates that the setting file does not exist, the instruction unit is configured to generate the setting file in which the expected value is set, select a third process of saving the generated setting file in the server, and execute the third process to perform the update instruction.

(Supplementary Note A9)

The operation management apparatus according to any one of Supplementary Notes A4 to A8, in which
in a case where the monitoring target information is a valid port for a network in a server included in the operation system and the actual setting value indicates that other port than the port is valid, the instruction unit is configured to select a fourth process of disabling the other port for the server, and execute the fourth process to perform the update instruction.

(Supplementary Note A10)

The operation management apparatus according to any one of Supplementary Notes A4 to A9, in which
in a case where the monitoring target information is an access control list of a network device included in the operation system and the actual setting value does not match setting information of the access control list indicated by the expected value, the instruction unit is configured to generate the access control list in which the expected value is set, select a fifth process of saving the generated access control list in the network device, and execute the fifth process to perform the update instruction.

(Supplementary Note A11)

The operation management apparatus according to any one of Supplementary Notes A1 to A10, in which
the definition information contains definitions of two or more items,
the generation unit is configured to generate the expected value table and the actual setting value table each including a first column corresponding to a first item and a second column corresponding to a second item,
the storage unit is configured to respectively store first and second expected values corresponding to the first and second items in the first and second columns in the actual setting value table, and store first and second actual setting values corresponding to the first and second items in the first and second columns in the actual setting value table,
the determination unit is configured to perform a first determination of comparing the first expected value with the first actual setting value and a second determination of comparing the second expected value with the second actual setting value, and
in a case where it is determined in the second determination that they do not match, the instruction unit is configured to perform an update instruction for the operation system from the second actual setting value to the second expected value based on the monitoring target information.

(Supplementary Note B1)

An operation management system including:
a monitoring target device that is included in an operation system and includes a monitoring agent; and
an operation management apparatus configured to monitor the operation system,
wherein the operation management apparatus includes:
a registration unit configured to register definition information defining an item of monitoring target information in the operation system; and
a generation unit configured to generate an expected value table and an actual setting value table each including a column corresponding to the item based on the definition information,
wherein the monitoring agent is configured to extract an actual setting value corresponding to the item from the monitoring target information acquired from the monitoring target device, and transmit the actual setting value to the operation management apparatus,
wherein the operation management apparatus further includes:
a storage unit configured to store an expected value corresponding to the item input from an outside in the column in the expected value table, and store the actual setting value received from the monitoring agent in the column in the actual setting value table;
a determination unit configured to compare the expected value with the actual setting value based on the definition information to determine whether the expected value and the actual setting value match or not; and
an instruction unit configured to output, to the monitoring agent, an update instruction from the actual setting value to the expected value in a case where the expected value does not match the actual setting value,
wherein the monitoring agent is configured to update the actual setting value to the expected value in response to the update instruction.

(Supplementary Note B2)

The operation management system according to Supplementary Note B1, wherein
the monitoring agent is configured to:
store the actual setting value in a queue in a case where communication with the operation management apparatus is not available; and
transmit the actual setting value to the operation management apparatus in accordance with the queue after the communication with the operation management apparatus is restored.

(Supplementary Note C1)

An operation management method of causing a computer to execute:
registering definition information defining an item of monitoring target information in an operation system;
generating an expected value table and an actual setting value table each including a column corresponding to the item based on the definition information;
storing an expected value corresponding to the item input from an outside in the column in the expected value table;
storing an actual setting value corresponding to the item contained in the monitoring target information acquired from the operation system in the column in the actual setting value table;
comparing the expected value with the actual setting value based on the definition information to determine whether the expected value and the actual setting value match or not; and
performing an update instruction for the operation system from the actual setting value to the expected value in a case where the expected value does not match the actual setting value.

(Supplementary Note D1)

An operation management program causing a computer to execute:
a registration process of registering definition information defining an item of monitoring target information in an operation system;
a generation process of generating an expected value table and an actual setting value table each including a column corresponding to the item based on the definition information;
a storage process of storing an expected value corresponding to the item input from an outside in the column in the expected value table, and storing an actual setting value corresponding to the item contained in the monitoring target information acquired from the operation system in the column in the actual setting value table;
a determination process of comparing the expected value with the actual setting value based on the definition information to determine whether the expected value and the actual setting value match or not; and
an instruction process of performing an update instruction for the operation system from the actual setting value to the expected value in a case where the expected value does not match the actual setting value.

The present invention has been described with reference to the example embodiments (and examples). However, the present invention is not limited to the above-described example embodiments (and examples). Various changes that can be understood by those skilled in the art can be made to the configurations and details of the present invention within the scope of the present invention.

This application claims priority based on Japanese Patent Application No. 2021-045834 filed on Mar. 19, 2021, the entire disclosure of which is incorporated herein.

### REFERENCE SIGNS LIST

1 OPERATION MANAGEMENT APPARATUS
11 REGISTRATION UNIT
12 GENERATION UNIT
13 STORAGE UNIT
14 DETERMINATION UNIT
15 INSTRUCTION UNIT
1000 OPERATION MANAGEMENT SYSTEM
1000a OPERATION MANAGEMENT SYSTEM
100 OPERATION SYSTEM
100a OPERATION SYSTEM
110 SERVER
110a SERVER
111 SETTING INFORMATION
112 LOG FILE
113 REPAIR AGENT
1131 MONITORING UNIT
1132 EXTRACTION UNIT
1133 TRANSMISSION UNIT
1134 REPAIR UNIT
114 EXTRACTION LOGIC
115 QUEUE
1151 ACTUAL SETTING VALUE
1152 ACTUAL SETTING VALUE
120 NETWORK DEVICE
121 ACCESS CONTROL LIST
200 MANAGEMENT TERMINAL
300 OPERATION MANAGEMENT APPARATUS
300a OPERATION MANAGEMENT APPARATUS
310 MEMORY UNIT
311 PROGRAM
312 MONITORING TARGET CONNECTION INFORMATION
313 DEFINITION INFORMATION
3131 MONITORING TARGET DEFINITION INFORMATION
3132 COLUMN DEFINITION INFORMATION
314 EXTRACTION LOGIC
315 SETTING FILE TEMPLATE
316 COMPARISON DB
31611 EXPECTED VALUE TABLE
31612 EXPECTED VALUE TABLE
31621 ACTUAL SETTING VALUE TABLE
31622 ACTUAL SETTING VALUE TABLE
317 REPAIR DEFINITION INFORMATION
318 WORKFLOW DEFINITION INFORMATION
319 TOOL GROUP
320 MEMORY
330 COMMUNICATION UNIT
340 CONTROL UNIT
341 REGISTRATION UNIT
342 GENERATION UNIT
343 STORAGE UNIT
344 DETERMINATION UNIT
345 INSTRUCTION UNIT
N NETWORK

What is claimed is:

1. An operation management apparatus comprising:
a memory storing instructions; and
a processor configured to execute the instructions to:
register definition information defining an item of monitoring target information in an operation system;
generate an expected value table and an actual setting value table each comprising a column corresponding to the item based on the definition information;
store an expected value corresponding to the item input from an outside in the column in the expected value table, and storing an actual setting value corresponding to the item contained in the monitoring target information acquired from the operation system in the column in the actual setting value table;
compare the expected value with the actual setting value based on the definition information to determine whether they match or not; and
perform an update instruction for the operation system from the actual setting value to the expected value in a case where the expected value does not match the actual setting value.

2. The operation management apparatus according to claim 1, wherein
the processor is configured to add a set of table names of the expected value table and the generated actual setting value table to the definition information, and
the processor is configured to identify the expected value table and the actual setting value table based on the set of table names, and compare the expected value stored in the column in the identified expected value table with the actual setting value stored in the column in the identified actual setting value table.

3. The operation management apparatus according to claim 1, wherein
the processor is configured to further generate an extraction logic that extracts the actual setting value corresponding to the item from the monitoring target information based on the definition information, and
the processor is configured to extract the actual setting value from the monitoring target information acquired from the operation system using the extraction logic, and store the extracted actual setting value in the column in the actual setting value table.

4. The operation management apparatus according to claim 1, wherein
the processor is configured to select a process according to a column in which the expected value does not match the actual setting value from among a plurality of processes for the operation system, and execute the process to perform the update instruction.

5. The operation management apparatus according to claim 4, wherein
the processor is configured to select a process according to the column further based on the actual setting value.

6. The operation management apparatus according to claim 4, wherein
in a case where the monitoring target information is a process that is running on a server included in the operation system and the actual setting value indicates that the process is not running, the processor is configured to select a first process of restarting the process, and execute the first process to perform the update instruction.

7. The operation management apparatus according to claim 6, wherein
in a case where the execution of the first process fails, the processor is configured to further select a second process of installing an execution file corresponding to the process in the server and executing the execution file, and execute the second process to perform the update instruction.

8. The operation management apparatus according to claim 4, wherein
in a case where the monitoring target information is a setting file in a server included in the operation system and the actual setting value indicates that the setting file does not exist, the processor is configured to generate the setting file in which the expected value is set, select a third process of saving the generated setting file in the server, and execute the third process to perform the update instruction.

9. The operation management apparatus according to claim 4, wherein
in a case where the monitoring target information is a valid port for a network in a server included in the operation system and the actual setting value indicates that other port than the port is valid, the processor is configured to select a fourth process of disabling the other port for the server, and execute the fourth process to perform the update instruction.

10. The operation management apparatus according to claim 4, wherein
in a case where the monitoring target information is an access control list of a network device included in the operation system and the actual setting value does not match setting information of the access control list indicated by the expected value, the processor is configured to generate the access control list in which the expected value is set, select a fifth process of saving the generated access control list in the network device, and execute the fifth process to perform the update instruction.

11. An operation management system comprising:
a monitoring target device that is included in an operation system and includes a monitoring agent; and
an operation management apparatus configured to monitor the operation system,
wherein the operation management apparatus comprises:
a memory storing instructions; and
a processor configured to execute the instructions to:
register definition information defining an item of monitoring target information in the operation system; and
generate an expected value table and an actual setting value table each including a column corresponding to the item based on the definition information,
wherein the monitoring agent is configured to extract an actual setting value corresponding to the item from the monitoring target information acquired from the monitoring target device and transmits the actual setting value to the operation management apparatus,
wherein the processor is further configured to:
store an expected value corresponding to the item input from an outside in the column in the expected value table, and storing the actual setting value received from the monitoring agent in the column in the actual setting value table;
compare the expected value with the actual setting value based on the definition information to determine whether the expected value and the actual setting value match or not; and
output, to the monitoring agent, an update instruction from the actual setting value to the expected value in a case where the expected value does not match the actual setting value, and
wherein the monitoring agent is configured to update the actual setting value to the expected value in response to the update instruction.

12. The operation management system according to claim 11, wherein
the monitoring agent is configured to:
store the actual setting value in a queue in a case where communication with the operation management apparatus is not available; and
transmit the actual setting value to the operation management apparatus in accordance with the queue after the communication with the operation management apparatus is restored.

13. (canceled)

14. An operation management program for causing a computer to execute:
a registration process of registering definition information defining an item of monitoring target information in an operation system;
a generation process of generating an expected value table and an actual setting value table each including a column corresponding to the item based on the definition information;
a storage process of storing an expected value corresponding to the item input from an outside in the column in the expected value table, and storing an actual setting value corresponding to the item contained in the monitoring target information acquired from the operation system in the column in the actual setting value table;
a determination process of comparing the expected value with the actual setting value based on the definition information to determine whether the expected value and the actual setting value match or not; and
an instruction process of performing an update instruction for the operation system from the actual setting value to the expected value in a case where the expected value does not match the actual setting value.
